(19) United States
(12) Patent Application Publication
(10) Pub. No.: US 2021/0021747 A1
(43) Pub. Date: Jan. 21, 2021

(54) AUTONOMOUS DEVICE FOR ADVANCED IMAGE ANALYSIS, INTELLIGENT IMAGE RECOGNITION AND IMAGE EVALUATION

(71) Applicant: SANEZOO SE, Brno (CZ)

(72) Inventors: Lubos Brzobohaty, Brno (CZ); Lubos Lorenc, Brno (CZ); Roman Soucek, Brno (CZ)

(73) Assignee: SANEZOO SE, Brno (CZ)

(21) Appl. No.: 17/040,161

(22) PCT Filed: Mar. 22, 2019
(86) PCT No.: PCT/CZ2019/050012

§ 371 Date: Sep. 22, 2020

(30) Foreign Application Priority Data
Mar. 23, 2018 (CZ) 2018-148

(51) Int. Cl. H04N 5/225; G06T 7/00

(52) U.S. Cl. CPC H04N 5/22521; G06T 7/0004; H04N 5/2253; H04N 5/2252

(57) ABSTRACT

An autonomous device for image recognition comprising a housing in which a camera block (1) with an image sensor (11) and a process block (2) with at least one process unit (12) are stored, where both of these blocks (1,2) are separated from each other by means of a thermal insulation partition (3), wherein the camera block (1) and the process block (2) are signal-connected by a connecting element (20) and electrically powered, where the camera block (1) has a camera block (1) housing (6) formed by a base (61) provided with ribbing (24) and a cover (8) with an aperture (10) provided with a lens (17) of a camera module (16) with an image sensor (11) which is covered by a lens cover (46) with a lens slit (47), where the lens cover (46) is attached to the camera block base (61) by means of lens cover fastening screws (48), and the process block (2) has a process block (2) housing (7) formed by a base (71) provided with ribbing (24) and a cover (9) and a mounting cap (27), wherein between the housing (6) of the camera block (1) and the housing (7) of the process block (2), a thermal insulation partition (3) provided with an aperture (4) and a pair of thermal insulation inserts (50) is arranged, forming a channel (4b) through which a connecting element (20), that is formed by a cable (37), passes and which connects the printed circuit board (5) to the first heat pump (321) through the printed circuit board connector (39) and to the camera module (16) through the camera module connector (23), wherein a process unit (12) is disposed on the printed circuit board (5) located in the process block (2), and the printed circuit board (5) is further connected using a flexible portion (21) with a fixed expansion portion (22) of the printed circuit board on which a high speed connector (49) is arranged, wherein the printed circuit board (5) is further connected through a first stacking connector (331) and a second stacking connector (332) to the I/O plate (34) which is connected through an I/O connector (35) using the flexible portion (21) of the printed circuit board to the I/O connector plate (36) to which a GPIO connector (18) is connected, where the I/O plate (34) is connected to the supply printed circuit board (31) through a second stacking connector (332) and a third stacking connector (333), which supply printed circuit board is further connected by the cable (37) through a supply connector (38) to a power connector (19), and where a second heat pump (322) is arranged between the process block (2) housing (7) and the printed circuit board (5), and a third heat pump (323) is arranged between the process block (2) housing (7) and the supply printed circuit board (31).

### FIELD OF THE INVENTION

The invention relates to an autonomous device for advanced image analysis, intelligent image recognition and image evaluation comprising a housing, which includes a camera block with an image sensor and a process block with at least one process unit.

### BACKGROUND OF THE INVENTION

Currently, there has been a trend emerging in the field of industrial technologies to replace traditional mechanical measuring devices with cost-effective and easy-to-use image capture and recognition technology. An image sensor can bring advantages over mechanical measuring sensors in various industrial processes, especially in product quality control processes on the production line.

So far, the process of complete processing and evaluation of a video signal and/or machine vision takes place in such a way that a camera, eventually a smart camera, takes an image, whereupon a signal or part thereof is transmitted over a network or cable to another location where it is further processed and/or evaluated. In a typical machine vision configuration, image signal processing is performed in a system, such as an industrial computer, connected to a camera. Recently, an effort has been made to move functionality from external devices of a connected system to a process unit built directly into a camera. Camera manufacturers have been still more often offering so called “smart cameras” that can perform image pre-processing or processing directly on the camera. This trend continues and currently there have been cameras on the market in which it is possible to perform complete processing of the video signal up to the final decision on the processing result and its interpretation, for example up to the signal for a production line actuator.

A system comprising a method and an apparatus for recording an image sensor is disclosed in US Patent Application No. US2006092274 A1. This system, which facilitates quality control in the production line, includes an image sensor capturing a digital image of a manufactured article, and an indicator that indicates a problem manufacturing site or sites on a digital image to produce an annotated image. The system further includes a logical unit that compares the digital image with the annotated image and determines the quality of the item produced, wherein the annotated image defines an acceptable and unacceptable image parameter level for individual pixels of the digital image, wherein the image parameters include contrast. In addition, various artificial intelligence components can be used in conjunction with deducing whether an item can pass inspection criteria, and with a description of failed portions on a digital image.

A smart camera with modular expansion capability is described in US Patent Application No. US2003193571 A1. The smart camera includes a housing that has several sides and the camera is directly attached to the housing for obtaining an image of an object. The camera further comprises a functional unit arranged in the housing. The functional unit is connected to the camera and is configurable for implementation of the image processing function. Furthermore, a motherboard is provided in the housing to provide electrical power to the camera and a functional unit. The housing is provided with at least one aperture that includes a connector electrically coupled to the motherboard, the housing being adapted to receive a functional module with implemented image processing function. Dimensions of the camera are less than 30.48 cm in each side. The functional unit may comprise a processor and a memory or a programmable hardware element, it can further comprise one or more processors and memories and/or one or more programmable hardware elements. The processor may be of any type and has to be capable of executing software instructions.

Other systems that address this issue by combining a process unit with a detecting unit into a single device have pointed out that it is not necessary to set up infrastructures, such as data cabling or different power needs, but at the same time face new challenges, such as larger camera dimensions, more camera waste heat, reduced space for physical attachment of other interfaces, such as connectors, limited computing power of the embedded computer over a standalone industrial computer, increased thermodynamic noise of image sensors at higher temperatures, and sensor position changes depending on thermal expansion of the material.

Merging a camera and a computer into one device leads to a tightening of ambient conditions under which the device can operate. For this reason, it is necessary to narrow the temperature range at which the equipment can be operated reliably. Drawbacks of technical solutions for image acquisition and evaluation constructed into autonomous devices, comprising generally one package in which a process unit and a sensor unit are arranged side by side with a detecting sensor are that they tend to heat each other. As a result, they have a narrowed working temperature range.

Heating causes thermal noise with a negative effect on the quality of the image captured, and in solutions with multiple cameras or light units, for example in solutions with two cameras or special lighting, due to thermal expansion, an undesirable shift in the positions of the cameras or lighting and subsequent inaccuracies in the reconstruction of the 3D image occur. Most of autonomous image processing and evaluation devices constructed within a single device face this problem. Cooling using active ventilation mechanisms is often not accepted in service, because such active ventilation is the site of potential sources of failure. The use of active ventilation is further complicated with dusty environment.

A portable device for license plate reading, speed detecting and face recognition is described in US Patent Application No. US2016132743 A1. The portable device includes a camera located on the front right and front left side of the system, allowing the system to capture images and recognize faces. The device further includes LED lighting, which is located in the proximity of cameras that point towards the visual direction and that allow capturing readable images even at night. In addition to the additional light elements, the device includes an Ethernet connection for connecting to the network, as well as a cooling device that eliminates the heat generated inside the device, a control card, a modem that continuously provides wireless communication and a top cover that surrounds the entire system.

US2015358511 discloses a security camera including an image capturing unit and a control unit that is connected to the capturing unit and is configured to process the image captured by the capturing unit. The security camera further comprises a first heat-generating frame that is installed to contact the surface of the control unit and a second heat-generating frame that is arranged to contact the first heat generating frame as well as other surfaces of the control unit.

US2006055820 discloses a video recording camera comprising an image sensor, a first housing, a second cover, an electronic circuit, and a thermal partition. The image sensor is located in the first cover and the electronic circuit is located in the second cover. The thermal partition has a first and a second side, the first side being located adjacent to the first housing and the second side being located adjacent to the second housing. The image sensor and other electronics, such as a processor board coupled to an image sensor or camera power supply, are located in separate chambers or housings that are separated from each other and insulated by a thermal partition. This minimizes the heat generated by the processor electronics or power supply that is transmitted to the image sensor area.

### SUMMARY OF THE INVENTION

The invention further aims to propose an autonomous device for image recognition, in which all necessary functions are provided in a single device. Thermal noise of the image sensor and the unwanted influence of the thermal expansion of materials on the reconstruction of the 3D image are eliminated with the help of such device.

The above stated aim is achieved by using an autonomous device for image recognition comprising a housing in which a camera block with an image sensor and a process block with at least one process unit are stored, where both of these blocks are separated from each other by means of a thermal insulation partition, wherein the camera block and the process block are signal-connected by a connecting element and electrically powered, the essence of which lies in that the camera block has a camera block housing formed by a base provided with ribbing and a cover with an aperture provided with a lens of an camera module with an image sensor which is covered by a lens cover with a lens slit, where the lens cover is attached to the camera block base by means of the lens cover fastening screws, and the process block has a process block housing formed by a base provided with ribbing and a cover and a mounting cap, wherein between the housing of the camera block and the housing of the process block, a thermal insulation partition provided with an aperture and a pair of thermal insulation inserts is arranged, forming a channel through which a connecting element, that is formed by a cable, passes and which connects the printed circuit board to the first heat pump through the printed circuit board connector and to the camera module through the camera module connector, wherein a process unit is disposed on the printed circuit board located in the process block, and the printed circuit board is further connected using a flexible portion with a fixed expansion portion of the printed circuit board on which a high speed connector is arranged, wherein the printed circuit board is further connected through a first stacking connector and a second stacking connector to the I/O plate which is connected through an I/O connector using the flexible portion of the printed circuit board to the I/O connector plate to which a GPIO connector is connected, where the I/O plate is connected to the supply printed circuit board through a second stacking connector and a third stacking connector, which supply printed circuit board is further connected by the cable through a supply connector to a power connector, and where a second heat pump is arranged between the process block housing and the printed circuit board, and a third heat pump is arranged between the process block housing and the supply printed circuit board.

The invention is characterized by the separation of the process block and the camera block by means of a thermal insulation partition, which limits the heat transfer from the block of the autonomous heat-generating device to the block, which can be negatively affected by this heat. This results in a reduction in the temperature of the camera block and thus in the thermal noise of the image sensor and in the thermal expansion of materials.

Furthermore, the invention is characterized in that the autonomous device comprises a camera block housing which is formed by a base and a cover with an aperture, and a process block housing which is formed by a base and a cover between which a thermal partition is arranged, in which a connecting aperture is formed.

In addition to the best possible thermal insulation of the process and camera blocks, the thermal insulation partition also has the task of maintaining the strength of the equipment and the ability to firmly join the two blocks into a single unit. It is made of a sufficiently rigid material, which, however, has a significantly lower thermal conductivity than the material from which other parts are made, i.e. the camera and process block housings used to heat dissipation. At the same time, an aperture or slot can be formed in the thermal insulation partition through which it is possible to conduct signal and electrical interconnection of both blocks. The thermal insulation partition can be provided with connecting elements, which can be used to combine the whole device into a single unit.

For example, polyetheretherketone having a thermal conductivity coefficient of 0.25 W K⁻¹ m⁻¹ and suitable mechanical properties defined by a modulus of elasticity of 4,400 MPa may be preferably used to produce the thermal insulation partition. In addition, ABS with a thermal conductivity of 0.1 W K−1 m−1 and PVC with a thermal conductivity of 0.14-0.28 W K⁻¹ m⁻¹ and a modulus of elasticity of 1500 to 3,000 MPa can be used.

Furthermore, the invention is characterized in that the camera block has a housing of the camera block formed by a base and a cover, the cover being at least in part formed by a material transparent to the radiation detected.

Furthermore, the invention is characterized in that the camera block has a camera block housing formed by a base and a cover with an aperture. The aperture may be empty or filled with a material transparent to the radiation detected, which is in the case of light radiation glass or plastic.

Furthermore, the invention is characterized in that the process block is housed in a process block housing formed by a base and a cover. Between these blocks, a thermal insulation partition is provided in which a connecting aperture is preferably formed.

An advantage is that the connecting element is designed as a printed circuit board or a flexible circuit board or a cable or a fibre optic cable or a wireless communication element. In the case of the use of a printed circuit board, or a flexible portion of the printed circuit board, or a cable, or a fibre optic cable, this connecting element is guided through the connecting aperture in the thermal insulation partition. This connecting aperture in the thermal insulation partition may be provided as a slot or channel with the greatest length possible to prevent heat transfer.

In order to maintain the best possible mechanical properties of the autonomous device, the base and the cover of the camera and process block and the thermal insulation partition are provided with fastening means. The fastening means may be provided as housings and thermal insulation partitions parts in shape of part/counterpart, or as through-holes or apertures with nuts to fasten the fastening screws, or the fastening means may be provided as a glued joint, or a shank, or a bolt with screws.

For the best possible avoidance of forming of thermal bridges in the device, the fastening means can be made of a thermally less conductive material, for example a material from which the partition is made. The fastening means are introduced into the partition by a suitable method, for example by gluing or, when requesting higher operating temperatures, by spraying during the manufacture of the partition or by screwing. The fastening means may be placed in the partition arbitrarily. In a preferred embodiment, they are positioned opposite each other, which is a preferred arrangement from a structural point of view, since a higher rigidity of the assembled housing is thus achieved. This arrangement is also a preferred embodiment from the design point of view, since these fastening screws can be visible and the entire housing gives a symmetrical impression.

In order to provide mechanical strength, the fastening screws may be made of a thermally conductive material, such as stainless steel, and, over most of their length, they are located in a groove formed in the housing of the device, which enables them to cool into the surrounding space. In addition, at the points of contact with these housings, the screws are thermally insulated with insulation washers and inserts.

In order to provide electrical and signal interconnection of the camera block and the process block, a connecting means, such as a printed circuit board, which is common to both the camera block sensor and the process block components, including, for example, an electrical power source, power unit and image sensor unit with an image sensor, is routed through the connecting aperture in the thermal insulation partition.

Furthermore, the essence of the invention is that the connecting aperture must allow for the two blocks to be connected, but, at the same time, must not constitute a distinct thermal bridge. For this reason, the connecting aperture is designed as a slot allowing the connector, e.g., USB3, to extend.

The advantage of the device is that the thermal insulation partition is provided with a sufficiently large connecting aperture, which enables convenient threading of the connector. The connecting aperture in the thermal insulation partition is then closed on both sides by thermal insulation inserts, for example by gluing. If desired, the design of the thermal insulation inserts on both sides of the partition may be different, or the aperture in the partition may be configured to accommodate only one insert. This results in a double bend connecting channel in the thermal insulation partition, through which the signal and electrical connections are routed. Sufficient length of the connecting channel in the connecting aperture and its double bend have a significant effect on reducing the thermal transfer along the connecting member, since the thermal resistance of the conductor increases linearly with its increasing length, and in addition, the bend limits the airflow between the two blocks as it increases the pressure loss during air movement. During assembly, the inner space of the slot can be relatively easily filled with air-flow-preventing material, for example polyurethane foam. It is an advantage of the invention that the connecting aperture in the thermal insulation partition is designed as a channel with the greatest length possible, which can be additionally provided with thermal insulation.

Furthermore, the essence of the invention is that the camera and process blocks housings are made of a thermally conductive material, for example aluminium. These housings may be provided with ribbing to improve heat dissipation to the surroundings. The camera block cover may be made of metal or plastic, for example polyetheretherketone, ABS, or PVC, which is preferable if the camera module has to be thermally insulated from the camera block housing. The process block cover can also be made of metal or plastic, for example polyetheretherketone, which is preferable if it is necessary to provide permeability for Wi-Fi, Bluetooth, and the like.

Another advantage of the invention is that the camera block housing has a reinforced wall for effectively dissipating heat from the camera block. The location and design requirements of the reinforced wall are based on the design of the camera module used.

It is preferred that the camera block or process block is provided with at least one heat pump. The heat pump maintains the optimum temperature of the camera module or internal parts of the process block, thereby reducing the thermal stress of the camera module and the internal parts of the process block. Reducing thermal stress results in longer life and reliability of individual components. By keeping the temperature of the camera module in the optimum range, the image noise reduction in the image is also achieved, even at high computing unit load or when using an autonomous device in a space with a higher ambient temperature.

The term “heat pump” refers to any technical device that enables the temperature control of the internal parts of the process block and the camera module. It is preferred that the heat pump is a Peltier device. The principle of temperature control using the Peltier device is that when current passes through a circuit with two different conductors or semiconductors connected in series, one of their interfaces cools and the other heats. The Peltier device operates as a thermoelectric cooler (TEC). It draws heat on the cold side and gives the heat off on the hot side. By changing the polarity of the supply voltage, the hot and cold sides can be exchanged, allowing the Peltier device to both cool and heat.

The advantage of using a Peltier device as a heat pump is particularly that it has no moving parts, does not generate noise and vibrations.

The object of the present invention is to maintain the temperature of the image sensor at an optimum operating temperature interval. For this purpose, it is preferable if the camera module is thermally insulated from the camera block housing. For this reason, it is preferable if the camera block cover to which the camera module is attached is at least partially made of thermal insulation material and the interior of the camera block is filled with thermal insulation. The camera module is thermally coupled to the camera block housing only via a heat pump. By an appropriate mode of operation of the heat pump, the temperature of the camera module can be regulated to either higher or lower than the temperature of the camera block housing. In the same way, the temperature of the internal parts of the process block can be maintained at the optimal operating temperature interval.

For the same reason, it is advantageous if the inner space of the process block is filled with thermal insulation and if the internal parts of the process block are only thermally coupled to the process block housing via the heat pump. By an appropriate mode of operation of the heat pump, the temperature of the internal components of the process block can be regulated to either higher or lower temperature than the temperature of the process block housing.

A further advantage is that division of the autonomous device into two housings prevents the transfer of heat generated by the process block to the camera block and thus allows a lower temperature of the camera block casing to be achieved.

It is advantageous if the autonomous device has a printed circuit board (PCB) placed on the wall of the process block housing in the process block and connected by a flexible connection with the fixed expansion portion of the printed circuit board. Thus, it is achieved that the fixed expansion portion can be positioned outside the plane of the printed circuit board and thus accommodate to the requirements for the location of the connectors. Since everything is solved as one PCB, it is not necessary to connect cables between the motherboard and the connector board. This largely eliminates impedance misalignments at PCB-to-cable junctions and no deterioration in high-speed interface parameters deterioration in high-speed interface parameters occurs. All antistatic and overvoltage protection elements (ElectroStatic Discharge—ESD) and shielding and filter elements for ensuring electromagnetic compatibility (EMC) are located on the fixed expansion portion of the printed circuit board in the immediate vicinity of the connectors. In a preferred embodiment, the rear wall of the process block is designed as a removable mounting cap to facilitate mounting of the connectors.

To provide protection against the ingress of foreign particles or liquids into the autonomous device, all the joints in the block housings, including the lens mounting, can be sealed, for example with silicone seals.

To provide the highest possible computing power, this device can include multiple process blocks. Each process block can be separated from the other blocks by thermal insulation partitions, thus allowing different operating temperatures of the individual blocks to be achieved. The internal parts of the process block producing a substantial part of the waste heat are mainly the process unit and the power supply.

To increase the field of view, depth of sharpness, provision of spectral imaging, 3D image reconstruction, or, if it is preferable, to capture an object from different angles, the autonomous device may include multiple camera blocks. Each camera block may be separated from the other blocks of the autonomous device by thermal insulation partitions, thereby allowing different operating temperatures of the individual blocks to be achieved.

Furthermore, the essence of the invention is that multiple camera blocks and/or process blocks are arranged side by side and are separated from each other by thermal insulation partitions in which connecting apertures are provided to interconnect the individual blocks. The layout of the individual blocks of the autonomous device can be chosen with regard to their operating temperature requirements and their functionality. The connecting apertures in the thermal insulation partitions are designed to exhibit the lowest possible thermal conductivity.

Furthermore, the essence of the invention is that at least one camera module with a detecting sensor is arranged in the camera block.

To maintain a similar temperature of multiple camera modules located in a single camera block, these camera modules are preferably located on a common chassis of a thermally conductive material. The camera modules are thermally connected to each other through a thermally conductive chassis. The camera modules and the chassis are thermally insulated from the camera block housing and are only connected to it through the heat pump. Maintaining both camera modules, including the chassis, in a narrow operating temperature range is important to eliminate the thermal expansion of the chassis and camera modules, allowing to achieve correct image reconstructions, for example in case of a 3D image detecting or spectral detecting.

Furthermore, the essence of the invention is an autonomous device having a camera block comprising a housing formed by a base and a cover with an aperture and a process block comprising a housing formed by a base and a cover between which a thermal insulation partition having an aperture is provided through which a connecting element, formed by a printed circuit board, passes, on which an image sensor is located in the housing of the camera block and on which a process unit, a power supply unit, and a power supply are located in the housing of the process block.

Furthermore, the essence of the invention is an autonomous device, the essence of which is that the camera block comprises a housing formed by a base provided with ribbing and a cover with an aperture provided with a lens, and the process block comprises a housing formed by a base provided with ribbing and a cover and a mounting cap, wherein between the housing of the camera block and the housing of the process block is arranged a thermal insulation partition provided with an aperture formed as a slot, through which an connecting element, which forms a flexible portion of the printed circuit board, passes, where the flexible portion passing through the connector connects the camera block to the printed circuit board, which is located in the process block on which the process unit and the power unit are located, wherein the printed circuit board is connected by means of the flexible portion with a fixed expansion portion of the printed circuit board on which a power connector and a GPIO connector are located, wherein a camera module with an image sensor is located in the camera block and where fastening means pass through the camera block housing, the process block housing and the thermal insulation partition.

Furthermore, the essence of the invention is an autonomous device, the essence of which is that the camera block comprises a camera block housing formed by a base provided with ribbing and a cover with a lens cover slit, and the process block comprises a process block housing formed by a mounting cap, a cover, and a base provided with ribbing, where a camera module with an image sensor is located in the camera block, wherein between the housing of the camera block and the housing of the process block, a thermal insulation partition provided with an aperture and a pair of thermal insulation inserts are arranged, forming a channel through which a connecting element, that is formed by a cable, passes and which connects the printed circuit board to the first heat pump through the printed circuit board connector and to the camera module of the camera block through the camera module connector, wherein a process unit is disposed on the printed circuit board located in the process block and a first stacking connector is arranged thereon, and the printed circuit board is further connected using a flexible portion with a fixed expansion portion of the printed circuit board on which a high speed connector is arranged, wherein the printed circuit board is further connected through a first stacking connector and a second stacking connector to the I/O plate which is connected through an I/O connector using the flexible portion of the printed circuit board to the I/O connector plate to which a GPIO connector is connected, where the I/O plate is connected to the supply printed circuit board through a second stacking connector and a third stacking connector, supply printed circuit board being further connected by a cable through a supply connector to a power connector, and where a second heat pump is arranged between the process block housing and the printed circuit board, and a third heat pump is arranged between the process block housing and the supply printed circuit board.

Another advantage of such an autonomous device is the ability to operate even at different demands on the range of preferred or optimal operating temperatures of the individual blocks of the autonomous device, especially in long-term and continuous operation.

### BRIEF DESCRIPTION OF DRAWINGS

The present invention will be further illustrated by drawings, where

FIG. 1 shows a longitudinal section of an autonomous device in a basic embodiment with a single printed circuit board common to the detecting sensor and the process unit, FIG. 1a shows a front view of the device, FIG. 1b shows a cross-sectional view of the device as shown in FIG. 1, FIG. 1c shows a detail of an insulation partition with a connecting aperture in section, FIG. 1d shows a 3D view of an autonomous device in a basic embodiment;

FIG. 2 shows an autonomous device for image recognition in a first preferred embodiment with a single printed circuit board connected to a camera module by means of a flexible portion of a printed circuit board and with through apertures in a thermal insulation partition for fastening means, FIG. 2a shows a front view of the autonomous device in the first preferred embodiment, FIG. 2b shows a section of a process block in the first preferred embodiment, as shown in FIG. 2, FIG. 2c shows a detail of a thermal insulation partition with a connecting aperture in the first preferred embodiment, FIG. 2d shows an autonomous device for image recognition in the first preferred embodiment with four apertures in the thermal insulation partition on each side for fastening the fastening means from both sides, FIG. 2e shows a detail of the thermal insulation partition provided with fastening means, FIG. 2f shows a 3D view of the autonomous device in the first preferred embodiment;

FIG. 3 shows an autonomous device in a second preferred embodiment with heat pumps and three PCB boards, FIG. 3a shows a section of an autonomous device process block in the second preferred embodiment of the invention as shown in FIG. 3, FIG. 3b shows a detail of the process block of the second preferred embodiment of the invention with a sealing, FIG. 3c shows a detail a housing with a groove, FIG. 3d shows a detail of the housing with a groove provided with thermal insulation, FIG. 3e shows a thermal insulation partition assembly with insulating inserts and fastening means, FIG. 3f shows a detail of the insulating insert, FIG. 3g shows a preferred embodiment of a narrowed insulation partition assembly with thermal insulation inserts and a connecting channel;

FIG. 4 shows an arrangement of two camera modules on a chassis in one camera block, FIG. 4a shows an arrangement of an autonomous device with two camera and process blocks;

FIG. 5 shows a schematic connection of an autonomous device in a basic embodiment;

FIG. 6 shows a schematic connection of a first preferred embodiment of an autonomous device with galvanically isolated inputs and outputs; and

FIG. 7 shows a schematic connection of an autonomous device in a second preferred embodiment with heat pumps.

### EXEMPLARY EMBODIMENTS OF THE INVENTION

The invention will be explained in more detail by way of example with reference to the corresponding drawings. In the drawings and figures, the solution is shown in an exemplary embodiment, which is not limiting to other variations of the present summary of the invention, or to variants that are apparent to one skilled in the art.

For a description of the function of an autonomous device (AD), the following definitions are used, which will be further used in the description below.

Detecting device with an image sensor—is a device for image digital signal acquisition. It includes not only classic cameras and raster scan camera modules, but also line cameras, 3D cameras, cameras with spectral and hyperspectral sensors, thermocameras, X-ray sensors and other devices with sensors producing digital signal.
Camera Block—is a part of AD that acts as a digital camera and is a source of image signal for AD.
Interface Unit—is a set of electronic technical means allowing the connection and communication of AD with external devices.
Process Unit—is an electronic technical means or hardware device, a set of electronic circuits with computational power allowing for operation of neural networks and other computationally intensive, such as matrix, algorithms for advanced processing of images and other signals. It is designed for a high level of data processing parallelism. The process unit may include one or more memory blocks as well as one or more interface units.
Autonomous Device—is a device with at least one camera block and at least one process block built into a single unit, capable of functioning independently of the data infrastructure and other hardware.
Process block—consists of a motherboard to which one or more process units are connected. The process block may include one or more interface units and one or more interfaces for connecting camera blocks and/or process blocks.
Power Supply Unit—ensures the power supply of each AD blocks by electric power and, optionally, the power supply of external devices connected via interface units.
Camera module—is a technical means including an image sensor and a control unit for providing control of the image sensor and its signal connection and power supply.

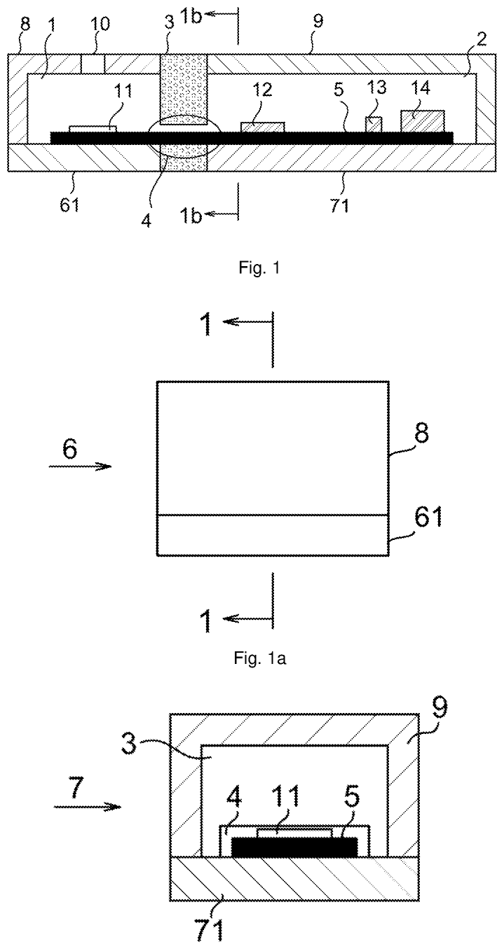

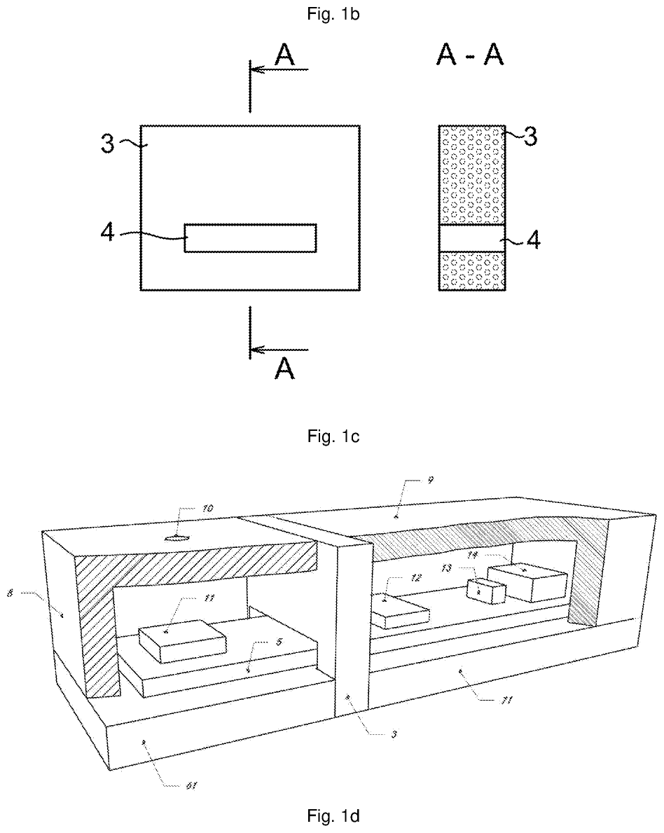

The autonomous device for image recognition of the basic embodiment is shown in FIG. 1, FIG. 1a, FIG. 1b, FIG. 1c and FIG. 1d. The autonomous device consists of a camera block 1 comprising a housing 6 in which a printed circuit board 5 with a mounted image sensor 11 is arranged. The housing 6 is formed by a base 61 and a cover 8 of the camera block 1 is U-shaped. In the cover 8 of the camera block 1, an aperture 10 for detecting is provided in which a transparent material for the detected radiation is placed, which allows the detected radiation to enter the image sensor 11 from the environment. The camera block 1 cover 8 abuts the base 61. The camera block 1 housing 6 is fastened on one side to the thermal insulation partition 3 which separates the camera block 1 from the process block 2, wherein the bond is formed by an adhesive bond. The thermal insulation partition 3 is formed by ABS having a thermal conductivity of 0.1 W K⁻¹ m⁻¹ and a modulus of elasticity of 2,137 MPa.

As shown in FIG. 1c, a connecting aperture 4 for electrical and signal connection of the process block 2 components and camera block 1 components is formed in the thermal insulation partition 3. From FIG. 1 and FIG. 1b it is further apparent, that the autonomous device further consists of a process block 2, which includes a housing 7. This housing 7 is formed by base 71 and cover 9 of the process block 2. The cover 9 of process block 2 is U-shaped and abuts base 71, as shown in FIG. 1b. The process block 2 is attached to the thermal insulation partition 3 from the opposite side than the camera block 1 by means of a glued joint.

The arrangement of the individual electronic components on the printed circuit board 5 is shown in FIG. 1 and FIG. 1d. In this embodiment, the printed circuit board 5 forms a single unit and provides electrical and signal connection to the process block 2 and the camera block 1. This printed circuit board 5 passes through the connecting aperture 4 in the thermal insulation partition 3 and abuts the base 71 of the process block 2 housing 7 and the base 61 of the housing 6 of the camera block 1. The printed circuit board 5 functions as a connecting means 20. The image sensor 11 of the camera block 1 and components of the process block 2 are mounted on the printed circuit board 5. The components include a battery, such as an electrical power source 14, a power unit 13 and a process unit 12.

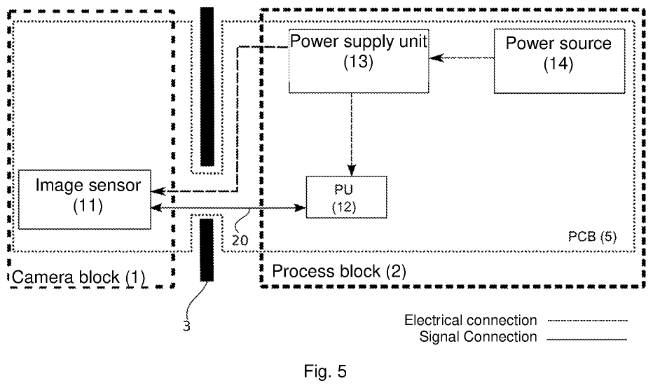

Block connection of individual camera block 1 and process block 2 components and the AD electric and signal paths thereof are shown in FIG. 5. In this embodiment, the connection comprises an image sensor 11 of the camera block 1, which is connected to the printed circuit board 5 passing through the connecting aperture 4 in the thermal insulation partition 3 and to which the process unit 12 of the process block 2 is connected. The image sensor 11 is signal-connected to the process unit 12 via this printed circuit board 5. The power source 14, for example a battery, is electrically connected via a printed circuit board 5 to a power supply unit 13, which is further connected to both the image sensor 11 and the process unit 12.

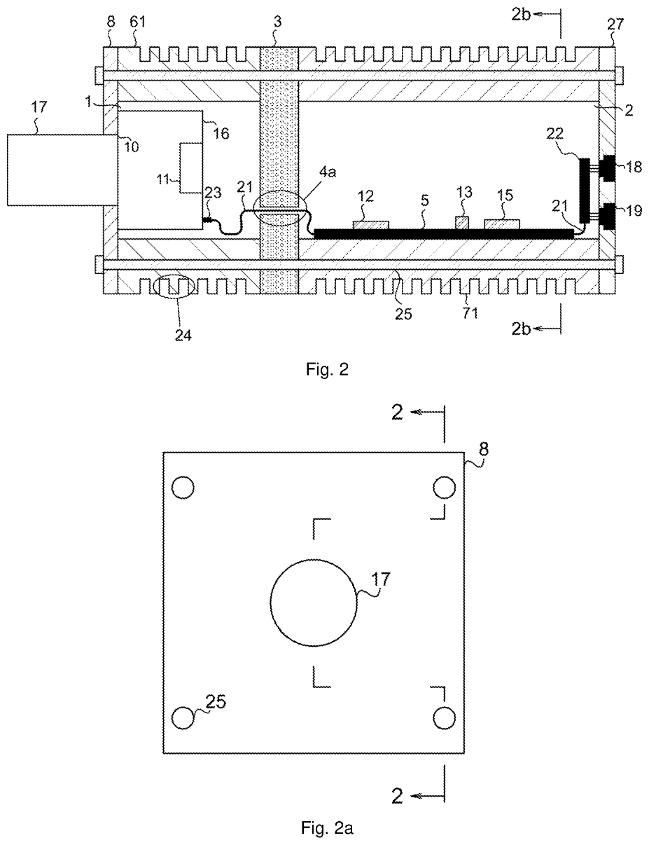

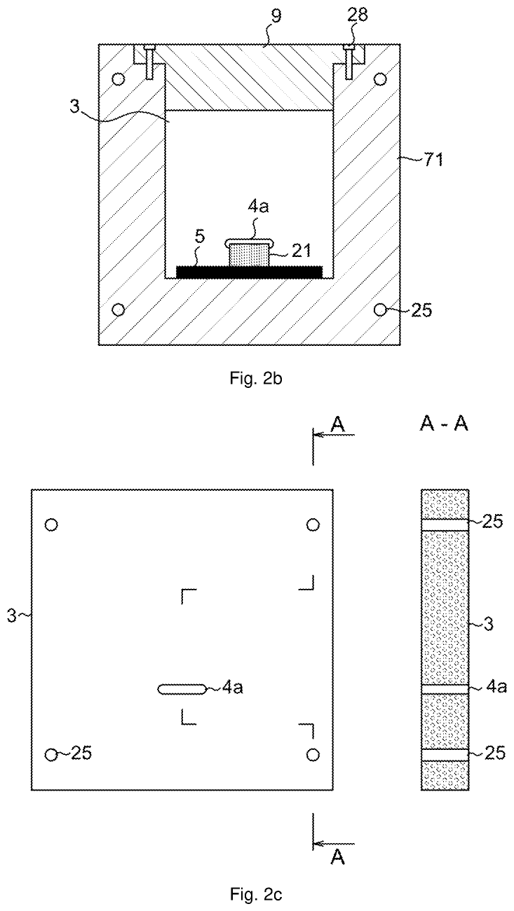

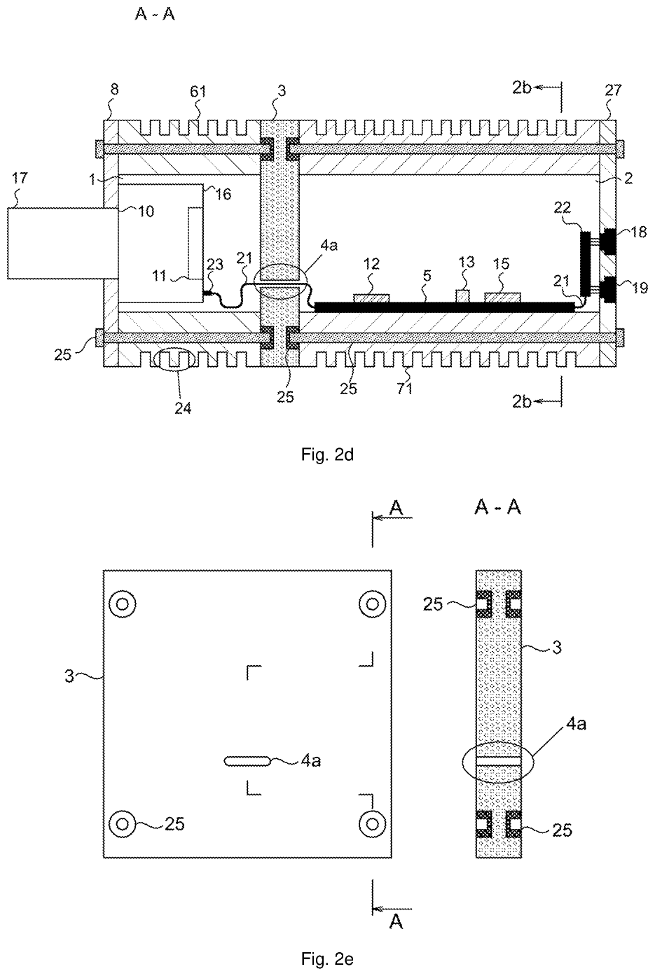

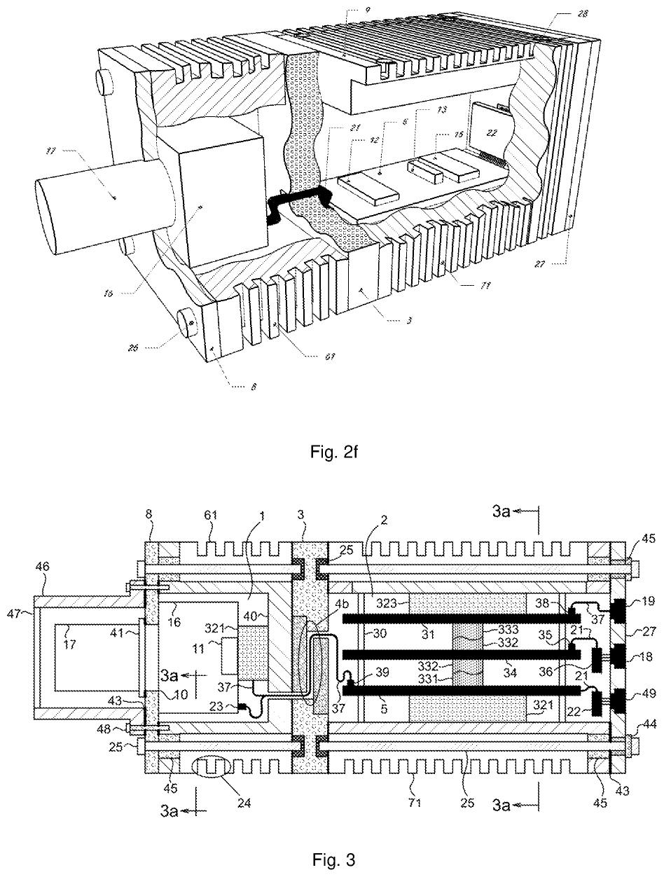

A further example of an embodiment of the autonomous device for image recognition is shown in FIG. 2, FIG. 2a, FIG. 2b, FIG. 2c, FIG. 2d, FIG. 2e and FIG. 2f. AD in this embodiment consists of a process block 2 and a camera block 1, which are separated from each other by a thermal insulation partition 3. The housing 7 of the process block 2 is formed by a base 71 and a process block cover 9, which is fastened to the base 71 of the process block housing 7 by screws 28. In addition, in this embodiment, the housing 7 of the process block 2 is provided with a mounting cap 27 from its rear side. The thermal insulation partition 3, the base 71 of the process block 2, the base 61 of the camera block 1, and the mounting cap 27 are connected to each other by fastening means 25. The thermal insulation partition 3 is made of non-softened PVC having a thermal conductivity of 0.28 W K⁻¹ m⁻¹ and a modulus of elasticity of 3,000 MPa, and preferably has a thermal conductivity of 0.14 W K⁻¹ m⁻¹ and modulus of elasticity 1,500 MPa.

The base 61 of the camera block 1 and the base 71 of the process block 2 are U-shaped. The camera block 1 is provided with a camera block 1 cover 8 from the front side. The camera block 1 cover 8 is made of a thermally conductive material such as aluminium. The fastening means 25 are arranged both in the camera block 1 and in the insulation partition 3, and thus also in the process block 2, and are formed as apertures, screws, and nuts.

As shown in FIG. 2 and FIG. 2c, these fastening means 25 are formed as through apertures in the thermal insulation partition 3, in the base 71 of the process block 2, in the base 61 of the camera block 1, and in the mounting cap 27, through which the fastening screws pass. These screws are made of a thermally insulating material, such as polyetheretherketone, with a modulus of elasticity of 4,400 MPa and a thermal conductivity of 0.25 W K⁻¹ m⁻¹ to prevent the formation of a thermal bridge through the thermal insulation partition 3. The fastening screws are at their ends secured with nuts.

FIG. 2d and FIG. 2e show another embodiment variant of the fastening means 25. In this embodiment, the fastening means 25 are provided as apertures with nuts arranged in the thermal insulation partition 3 from both sides. The fastening screws are guided through the mounting cap 27 and the base 71 of the process block 2 into the thermal insulation partition 3 where they are fastened. Other fastening screws are guided through the camera block cover 8 and the camera block 1 base 61 into the thermal insulation partition 3 where they are fastened. In this embodiment, the screws can be made of metal, since the thermal bridge in the thermal insulation partition 3 in the space between the fastening means 25 is interrupted by the thermal insulation material of the partition 3.

Both housings 6 and 7 of the camera and process blocks 1 and 2 are provided on their outer walls with ribbing 24 for dissipating heat from their walls into the environment. The camera block 1 in this embodiment includes a camera module 16 and a lens 17 disposed in the detecting aperture 10. The camera module 16 further comprises a sensor 11, an image sensor control unit and a camera module 16 connector 23. In this embodiment, the process block 2 is formed by a printed circuit board 5 on which a process unit 12 is installed. Further, a power supply unit 13 and a galvanic insulator 15 are installed on the printed circuit board 5. Furthermore, a fixed expansion portion 22 of the printed circuit board is fastened to the printed circuit board 5, which is electrically and signally connected to the printed circuit board 5 by a flexible portion 21 of the printed circuit board. The mounting cap 27 is provided with an aperture for a GPIO connector 18 providing signal communication with external devices and with an aperture for a power connector 19 that provides power supply from an external source, such as from electrical network.

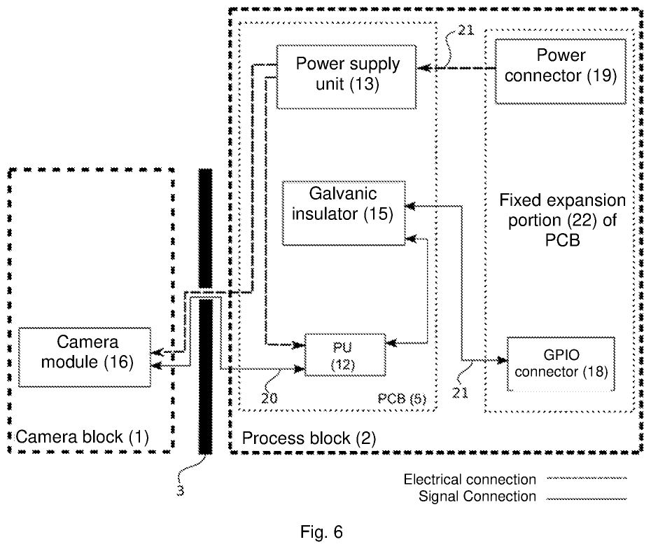

Block connection of the individual camera block 1 and the process block 2 components and the AD electric and signal paths thereof are shown in FIG. 6. In this embodiment, the connection comprises a camera module 16, which is signal-connected to the process unit 12 by means of a connecting element 20. The process unit 12 is bilaterally signal-connected to a galvanic insulator 15, which is further bilaterally signal-connected to the GPIO connector 18. The signal connection of the camera module 16 to the process unit 12 and of the galvanic insulator 15 to the GPIO connector 18 is realized using a flexible portion 21 of the printed circuit board. The signal connection of the process unit 12 and the galvanic insulator 15 is realized through the printed circuit board 5.

The power connector 19 is electrically connected to the power supply unit 13 via a flexible portion 21 of the printed circuit board 5. The power supply unit 13 is further electrically connected to the process unit 12 and to the galvanic insulator 15 by means of a printed circuit board 5. Further, the power supply unit 13 is electrically connected to the camera module 16 by means of a flexible portion 21 of the printed circuit board 5 via the camera module connector 23.

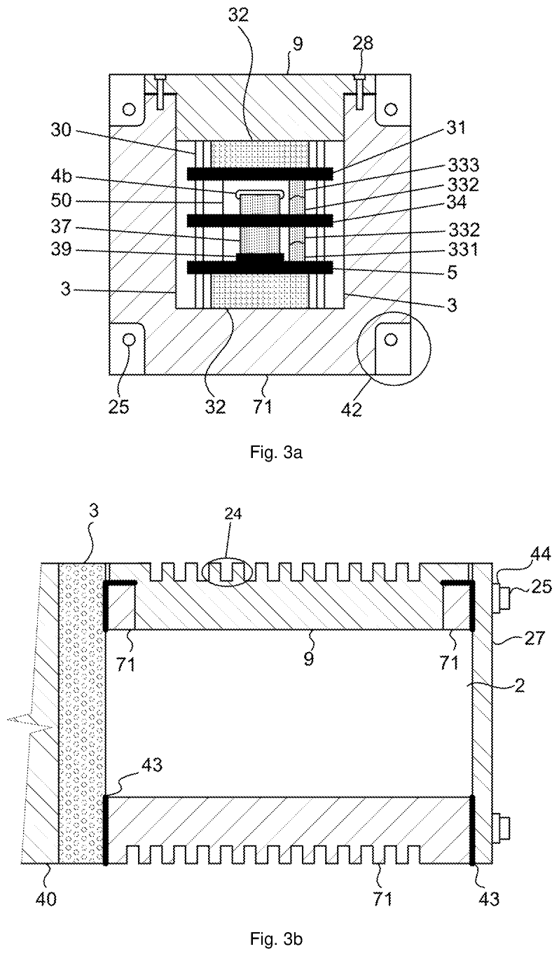

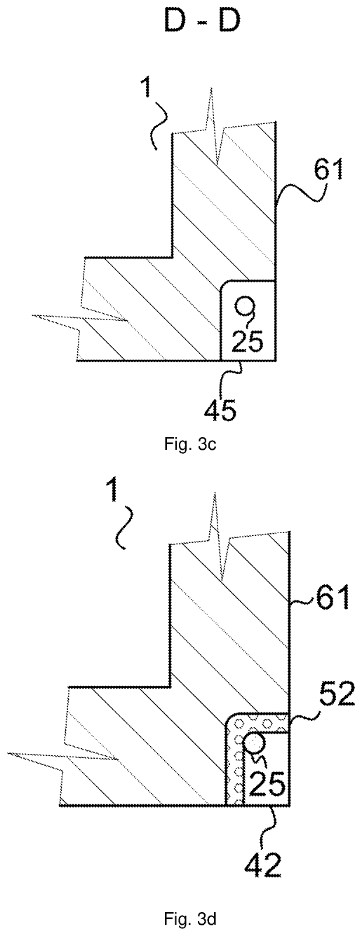

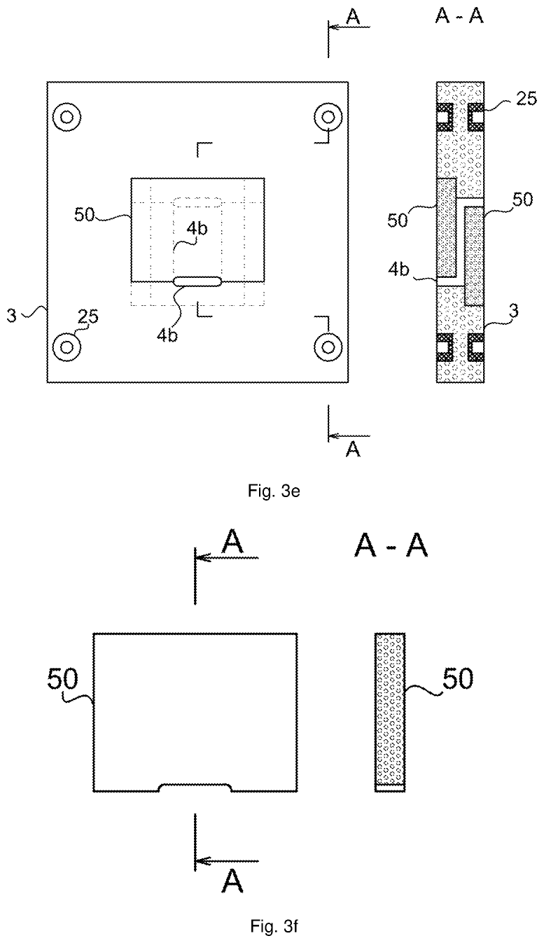

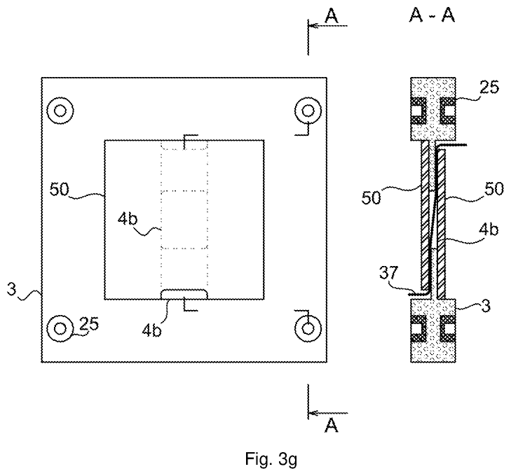

Another exemplary embodiment of the autonomous device for image recognition is shown in FIG. 3, FIG. 3a, FIG. 3b, FIG. 3c, FIG. 3d, FIG. 3e, FIG. 3f, and FIG. 3g. In this embodiment, AD consists of a camera block 1 and a process block 2 which are separated from each other by a thermal insulation partition 3. In this embodiment, the housing 7 of the process block 2 is also provided with a mounting cap 27, and the housing 6 of the camera block 1 is also provided with a cover 8, which are fastened to their housings 7 and 6 by means of fastening means 25.

The camera block housing 6 consists of a base 61 of the camera block 1 with a reinforced portion 40 and a cover 8 of the camera block 1. In this embodiment, the camera block 1 cover 8 is made of a thermally insulating material, preferably polyetheretherketone, from which a thermal insulation partition 3 is also made. At the point connection of the camera block 1 cover 8 to the camera block 1 base 61 by the fastening means 25, the camera block 1 base 61 is provided with thermal inserts 45. In this embodiment, the lens 17 is provided with a recess 41 for tightening the seal and with a lens cover 46 with a slit 47 of the lens cover, which is attached to the base 61 of the camera block 1 housing 6 through the camera block cover 8 using the fastening screws 48 of the lens 17 cover 46. A first heat pump 321 is located in the space of the camera block 1 between the camera module 16 and the reinforced portion 40. A heat pump 32 is designed as a Peltier device. The remaining space of the camera block 1 can be filled with thermal insulation, for example polyurethane foam.

As shown in FIG. 3a, the process block cover 9 is removably attached to the base 71 of the process block 2 by means of screws 28. The thermal insulation partition 3, the base 71 of the process block 2, and the base 61 of the camera block are provided with fastening means 25. The base 61 of the camera block 1 and the base 71 of the process block are both U-shaped. The fastening means 25 in the housing 6 of the camera block 1 and in the housing 7 of the process block 2 are designed as through apertures, wherein the fastening means 25 in the thermal insulation partition 3 are formed as apertures with nuts in which the fastening screws of the camera block 1 and the process block 2 are fastened. Both of these camera and process blocks 1 and 2 housings 6 and 7 are provided with ribbing 24 on their outer walls to dissipate heat from their walls to the environment. The camera block 1 and the process block 2 have, at the location with the largest thermal bridge, the fastening means 25 provided with thermal insulation washers 44 and thermal insulation inserts 45 as shown in FIG. 3. As shown in FIG. 3a, the process block 1, as well as the camera block 2, has grooves 42 formed around the fastening means 25 to reduce heat transfer. It can also be seen from FIG. 3d that the grooves 42 can be provided with thermal insulation 52.

As can be seen in FIG. 3b and FIG. 3a, sealings 43 preventing ingress of dust, solids particles, and liquids into AD are arranged at the joints of individual housing 6 and 7 portions and the thermal insulation partition 3.

The aperture 4 in the thermal insulation partition 3 is provided with a pair of thermal insulation inserts 50, thereby forming a double-bend connection channel 4b in the thermal insulation partition 3, as shown in FIG. 3e. The thermal insulation inserts 50 are arranged in the thermal insulation partition 3 on both sides as shown in FIG. 3f. If desired, the embodiment of the thermal insulation inserts 50 may be different on either side, or the connecting aperture 4 in the thermal insulation partition 3 may be configured to accommodate only one thermally insulating insert 50. FIG. 3g shows a detail of an embodiment of a thermal insulation insert 50 adapted to achieve the smallest possible thickness, in order to better utilize the AD interior.

The arrangement of the components of the process block 2 is shown in FIG. 3 and FIG. 3a, where it includes, in addition to the printed circuit board 5, also a fixed expansion portion 22 of the printed circuit board 5, an I/O printed circuit board 34, an I/O connector plate 36 and a supply printed circuit board 31. The connecting means 20 is designed as a cable 37 which connects the camera module 16 through the camera module connector 23 to the printed circuit board 5, which is further connected by a flexible portion 21 of the printed circuit board 5 to the fixed expansion portion 22 of the printed circuit board 5 to which a high-speed data connector 49 is connected. The printed circuit board 5 is further connected by a first stacking connector 331 through a second stacking connector 332 to the I/O printed circuit board 34, which is connected through an I/O connector 35 using the flexible portion 21 of the printed circuit board to the I/O connector plate 36. The I/O plate 34 is connected to the supply printed circuit board 31 by a second stacking connector 332 through a third stacking connector 333, the supply printed circuit board being further connected to the power connector 19 by a cable 37 through a supply connector 38. The printed circuit board 5, the I/O printed circuit board 34, and the supply printed circuit board 31 are arranged one above the other and are spaced apart by spacers 30. The printed circuit board 5 and the supply printed circuit board 31 generate more waste heat and are positioned closer to the walls of the housing 7 of the process block 2, wherein a second heat pump 322 is disposed between the printed circuit board 5 and the housing 7 wall, and a third heat pump 323 is disposed between the supply printed circuit board 31 and the housing 7 wall. The heat pumps 32 dissipate heat from the plates 5 and 31 into the housing 7 of the process block 2.

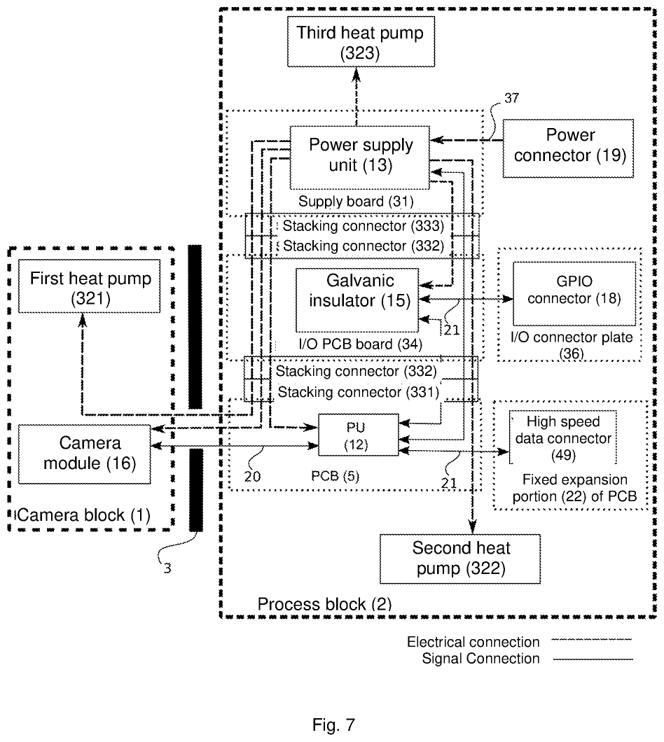

Block connection of individual camera block 1 and process block 2 components, and the AD electric and signal paths thereof, is shown in FIG. 7. In this embodiment, the connection comprises a camera block 1 with a camera module 16 and a first heat pump 321. The process block 2 includes a power supply unit 13 to which a power connector 19 is electrically connected. The power supply unit 13 is located on the printed circuit board 31. A galvanic insulator 15 is bilaterally signal-connected to the GPIO connector 18, which is located on the I/O connector plate 36, wherein the galvanic insulator 15 is arranged on the I/O board 34. The process unit 12 is arranged on the PCB printed circuit board 5 and is bilaterally signal-connected to the high-speed data connector 49, which is arranged on the fixed expansion portion 22 of the PCB board. The second heat pump 322 and the third heat pump 323 are electrically powered from the power supply unit 13 by stacking connectors 33 or by cables 37 which are not shown in the drawing.

The camera module 16 and the first heat pump 321 arranged in the camera block 1 are electrically powered from the power supply unit 13 through stacking connectors 33, the I/O board 34, the printed circuit board 5 and the connecting means 20. The camera module 16 is further bilaterally signal-connected to the process unit 12 using the connecting means 20, the process unit 12 is bilaterally signal-connected to the power supply unit 13 and to the galvanic isolator 15. The power supply unit 13 is further electrically connected to the process unit 12 and to the galvanic insulator 15. The signal and electrical connection of the power supply unit 13, the galvanic isolator 15, and the process unit 12 is performed by means of stacking connectors 33 and/or cables 37 which are not shown in the drawing.

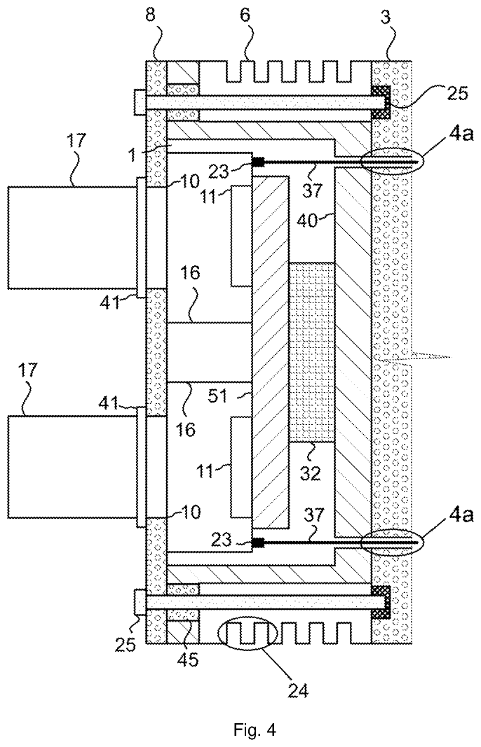

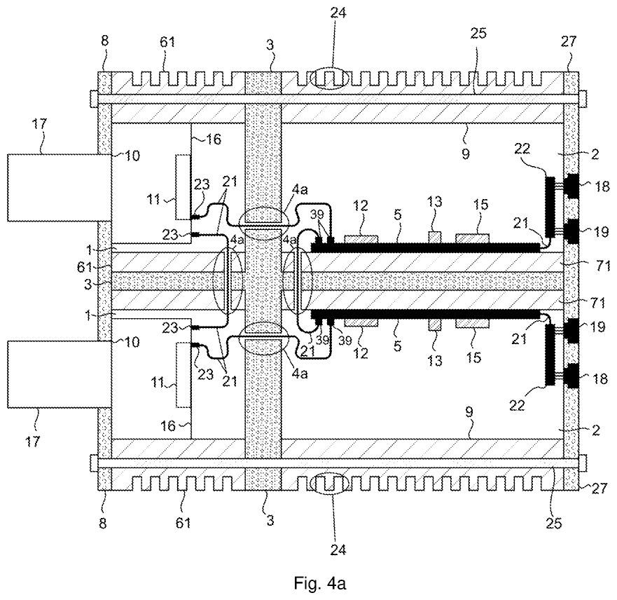

FIG. 4 further shows an embodiment of a camera block 1, which additionally comprises two camera modules 16 arranged on one chassis 51, wherein the camera modules 16 are powered by cables 37 passing through slots 4a in a thermal insulation partition 3. FIG. 4. further shows, that a heat pump 32 is placed between the chassis 51 and a reinforced portion 40 of the base 61 of the camera block 1, to maintain the chassis 51 and the camera modules 16 at the desired temperature. The chassis 51 is made of a thermally conductive material, allowing thermal interconnection of the two camera modules 16 and helping to maintain them at the same temperature. In this case, the camera block 1 cover 8 is made of a thermally insulating material, for example polyetheretherketone, and the interior of the camera block 1 is filled with thermal insulation, for example polyurethane foam.

FIG. 4 further shows an embodiment of an autonomous device consisting of two camera blocks 1 and two process blocks 2 connected together by flexible portions 21 of the printed circuit board. The camera blocks 1 are arranged side by side, having a common camera block 1 cover 8, in which two apertures 10 for detecting and for positioning the lenses 17 are formed. The camera and process blocks 1 and 2 are separated from each other by a thermal insulation partition 3. The thermal insulation partition 3 separates the camera and process blocks 1 and 2 in both horizontal and vertical directions, wherein an aperture 4 in the form of a connecting slot 4a is designed in each direction. The first and second camera blocks 2 are connected by a first connecting slot 4a. The first camera block 2 and the first process block 1 are connected by a second connecting slot 4a. The second camera block 2 and the second process block 1 are connected by a third connecting slot 4a. The second camera block and the first process block 1 are connected by a fourth connecting slot 4a.

### INDUSTRIAL APPLICABILITY

The invention finds application in industrial automation, particularly in production or control lines requiring continuous operation with continuous quality control of an industrial process, consisting in particular in recognizing products, such as parts, shapes, colours, or defects thereof.

### LIST OF REFERENCE NUMBERS

1 Camera block
2 Process block
3 Thermal insulation partition
4 Aperture in the thermal insulation partition
4a Slot
4b Channel
5 Printed circuit board (PCB)
6 Camera block housing
61 Camera block base
7 Process block housing
71 Process block base
8 Camera block cover
9 Process block cover
10 Detecting aperture
11 Image sensor
12 PU (Process unit)
13 Power supply unit
14 Power source
15 Galvanic insulator
16 Camera module
17 Lens
18 GPIO connector(s)
19 Power connector
20 Connecting means
21 Flexible portion of the printed circuit board
22 Fixed expansion portion of the printed circuit board
23 Camera module connector
24 Ribbing
25 Fastening means
26 Fastening screw
27 Mounting cap
28 Screw
29 Aperture for fastening means
30 Spacer
31 Supply printed circuit board
32 Heat pump
321 First heat pump
322 Second heat pump
323 Third heat pump
33 Stacking connector
331 First stacking connector
332 Second stacking connector
333 Third stacking connector
34 I/O printed circuit board
35 I/O connector
36 I/O connector plate
37 Cable
38 Supply connector
39 Printed circuit board connector
40 Reinforced wall of the camera block housing
41 Recess on the lens for tightening a seal
42 Groove to reduce heat transfer
43 Sealing
44 Thermal insulation washer
45 Thermal insulation insert
46 Lens cover
47 Lens cover slit
48 Lens cover fastening screw
49 High speed data connector
50 Thermal insulation partition insulation insert
51 Chassis
52 Insulation

1. An autonomous device for image recognition comprising a housing in which a camera block (1) with an image sensor (11) and a process block (2) with at least one process unit (12) are stored, where both of these blocks (1,2) are separated from each other by means of a thermal insulation partition (3), wherein the camera block (1) and the process block (2) are signal-connected by a connecting element (20) and electrically powered, characterised in that the camera block (1) has a camera block (1) housing (6) formed by a base (61) provided with ribbing (24) and a cover (8) with an aperture (10) provided with a lens (17) of an camera module (16) with an image sensor (11) which is covered by a lens cover (46) with a lens slit (47), where the lens cover (46) is attached to the camera block base (61) by means of the lens cover fastening screws (48), and the process block (2) has a process block (2) housing (7) formed by a base (71) provided with ribbing (24), with a cover (9) and with a mounting cap (27), wherein between the housing (6) of the camera block (1) and the housing (7) of the process block (2), a thermal insulation partition (3) provided with an aperture (4) and a pair of thermal insulation inserts (50) is arranged, forming a channel (4b) through which a connecting element (20), that is formed by a cable (37), passes, and which connects the printed circuit board (5) to the first heat pump (321) through the printed circuit board connector (39) and to the camera module (16) through the camera module connector (23), wherein a process unit (12) is disposed on the printed circuit board (5) located in the process block (2), and the printed circuit board (5) is further connected using a flexible portion (21) with a fixed expansion portion (22) of the printed circuit board on which a high speed connector (49) is arranged, wherein the printed circuit board (5) is further connected through a first stacking connector (331) and a second stacking connector (332) to the I/O plate (34) which is connected through an I/O connector (35) using the flexible portion (21) of the printed circuit board to the I/O connector plate (36) to which a GPIO connector (18) is connected, where the I/O plate (34) is connected to the supply printed circuit board (31) through a second stacking connector (332) and a third stacking connector (333), the supply printed circuit board being further connected by the cable (37) through a supply connector (38) to a power connector (19), and where a second heat pump (322) is arranged between the process block (2) housing (7) and the printed circuit board (5), and a third heat pump (323) is arranged between the process block (2) housing (7) and the supply printed circuit board (31).

2. An autonomous device according to claim 1, characterized in that the thermal insulation partition (3) is made of a material having a thermal conductivity of less than or equal to 0.28 W K⁻¹ m⁻¹.
